(19) United States
(12) Patent Application Publication
(10) Pub. No.: US 2025/0369824 A1
(43) Pub. Date: Dec. 4, 2025

(54) MEASUREMENT SYSTEM

(71) Applicant: FUJIFILM Corporation, Tokyo (JP)

(72) Inventor: Tadashi KASAMATSU, Kanagawa (JP)

(73) Assignee: FUJIFILM Corporation, Tokyo (JP)

(21) Appl. No.: 19/299,362

(22) Filed: Aug. 14, 2025

Related U.S. Application Data
(63) Continuation of application No. PCT/JP2023/046627, filed on Dec. 26, 2023.

(30) Foreign Application Priority Data
Feb. 17, 2023 (JP) 2023-023519

(51) Int. Cl. G01M 5/00

(52) U.S. Cl. CPC G01M 5/0091; G01M 5/0066

(57) ABSTRACT

The present invention enables to measure a three-dimensional shape and vibration of an object with a simple configuration. A measurement system includes: a laser light source that outputs frequency-modulated continuous wave laser light; a laser scanner that scans an object with the frequency-modulated continuous wave laser light; an interferometer that splits the frequency-modulated continuous wave laser light into reference light and measurement light, and inputs and causes the reference light and reflected light of the measurement light reflected by the object to interfere with each other; a shape measurer that measures a three-dimensional shape of the object based on a center frequency of a beat signal obtained by the interference; an FM demodulator that performs FM demodulation on the beat signal obtained by the interference to detect FM sidebands; and a vibration measurer that measures vibration of the object based on the FM sidebands obtained by the detection.

### CROSS-REFERENCE TO RELATED APPLICATIONS

The present application is a Continuation of PCT International Application No. PCT/JP2023/046627 filed on Dec. 26, 2023 claiming priority under 35 U.S.C § 119(a) to Japanese Patent Application No. 2023-023519 filed on Feb. 17, 2023. Each of the above applications is hereby expressly incorporated by reference, in its entirety, into the present application.

### BACKGROUND OF THE INVENTION

### 1. Field of the Invention

The present invention relates to a technology for measuring an object using laser light.

### 2. Description of the Related Art

### [Measurement for Social Infrastructure Structures]

Measurement of “social infrastructure structures” such as a road, a bridge, a tunnel, a dam, and a building, particularly for a concrete structure will be described. In recent years, inspection and maintenance (assessment of a condition of a structure, condition-based repairs, and the like) of so-called “social infrastructure structures” such as a road, a bridge, a tunnel, a dam, and a building have become a major social problem. In the inspection of these social infrastructure structures, it is necessary to grasp the presence or absence of damage (cracking, delamination, or the like) and a degree thereof, and thus a three-dimensional shape or vibration of the object is measured. It should be noted that “infra” is an abbreviation for “infrastructure”. In addition, the “concrete structure” is a structure made of concrete, but members other than concrete, such as a reinforcing bar and a steel frame, may be used.

In such concrete structures, “delamination” refers to a condition in which the near surface concrete loses its bond with the underlying concrete due to continuous internal cracking or construction defects exacerbated by service induced vibration or deformation (“https://www.tukigata.co.jp/publics/index/41/”; according to the website of “TSUKIGATA CO., LTD.”). In such a state, cracking occurs inside the concrete due to the corrosion of the reinforcing bar, and the surface of the concrete is pushed up, resulting in a protruding “delamination”. In addition, as described on the website, in the concrete in which delamination occurs, peeling occurs in a case in which deterioration progresses or a shock is applied.

Such progression of delamination or peeling is divided into, for example, “a latent period, a progression period, a pre-acceleration period, a post-acceleration period, and a deterioration period”, but it is said that “internal deterioration that can be detected by a tapping sound made by a person starts from the pre-acceleration period”. The “pre-acceleration period” is a state in which fissuring (cracking) occurs inside the reinforcing bar due to corrosion and expansion of the reinforcing bar, and deformation or cracking occurs on the surface, and the surface deformation is slight (it is presumed that the surface deformation is about 0.1 mm to 0.2 mm).

In the related art, a worker has visually confirmed the three-dimensional shape or the vibration of the object by a visual observation or the tapping sound. However, such work takes time and effort, and it may be difficult to approach an inspection target.

In such a situation, it is conceivable to apply a technology for measuring the object in a non-contact manner using laser light. FIG. 16 is a diagram showing a state in which a three-dimensional shape of an object 710 is measured using a laser scanner 700. In the example of FIG. 16, a protruding shape CV generated by deterioration (internal cracking 714, corrosion 716) of a reinforcing bar 712 is measured from a location at a distance of 5 m. In addition, it is known to measure a distance using a frequency-shifted feedback laser (FSF laser) (for example, see JP2021-096383A). JP2021-096383A also describes that a three-dimensional shape can be measured by scanning an object with the FSF laser (repeating distance measurement).

### SUMMARY OF THE INVENTION

In a case in which the three-dimensional shape of the object is measured, there is a possibility of erroneous detection or omission of detection in a case in which an influence of the shape derived from the construction (in some cases, an original shape is bulged or recessed) is superimposed on a measurement result. In addition, even in a case in which damage occurs, there is a possibility of omission of detection in a case in which a degree of damage is small. Therefore, it may be difficult to sufficiently inspect the object by only measuring the three-dimensional shape.

Therefore, it may be possible to use three-dimensional shape measurement and non-contact acoustic inspection (measurement of vibration) in combination. This is because, in a case in which the vibration of the damage can be measured, the damage can be detected and measured with higher accuracy. The non-contact acoustic inspection has the same principle as the tapping sound made by the worker, and for example, the vibration of the object generated by an excitation sound source (acoustic excitation source) is measured by a laser vibration meter or the like. A conceptual diagram of the non-contact acoustic inspection is shown in FIG. 17. In the example of FIG. 17, the vibration of the object 710 generated by an excitation sound source 730 is measured by using a laser scanner type vibration meter 720. Since the frequency of the vibration and the vibration intensity depend on the degree of damage, the degree of damage can be grasped by measuring the vibration.

However, in a case in which the above-described three-dimensional laser measurement and non-contact acoustic inspection are simply combined, the system becomes large and the cost increases.

As described above, in the related art, it is not possible to measure the three-dimensional shape and the vibration of the object with a simple configuration.

The present invention has been made in view of such circumstances, and an object of the present invention is to provide a measurement system capable of measuring a three-dimensional shape and vibration of an object with a simple configuration.

### [Basic Idea of Present Invention]

The inventors of the present application have conducted intensive studies on the combination of the three-dimensional shape measurement and the non-contact acoustic inspection described above, have found that the FSF laser as described in JP2021-096383A is a type of a frequency-modulated continuous wave (FMCW) laser and can be used as a light source of a laser Doppler vibrometer (LDV) of a “pseudo heterodyne method”, and have obtained an idea that “the system can be simplified by applying the FSF laser or the FMCW laser to the vibration measurement of the damage, that is, by using the laser light source for both the three-dimensional shape measurement and the vibration measurement” (an LDV of a heterodyne method is not suitable for distance measurement or three-dimensional shape measurement). Hereinafter, each of aspects of the present invention created based on such an idea will be described.

### [Each Aspect of Present Invention]

In order to achieve the above-described object, a first aspect of the present invention provides a measurement system comprising: a laser light source that outputs frequency-modulated continuous wave laser light; a laser scanner that scans an object with the frequency-modulated continuous wave laser light; an interferometer that splits the frequency-modulated continuous wave laser light into reference light and measurement light, and causes the reference light and reflected light of the measurement light reflected by the object to interfere with each other; a shape measurer that measures a three-dimensional shape of the object based on a center frequency of a beat signal obtained by the interference; an FM demodulator that performs FM demodulation on the beat signal obtained by the interference to detect FM sidebands; and a vibration measurer that measures vibration of the object based on the FM sidebands obtained by the detection.

In the first aspect, the center frequency of the beat signal obtained by the interference corresponds to a distance to a point irradiated with the laser light, so that the distances to a plurality of points can be obtained by scanning the object, and thus the three-dimensional shape of the object can be measured. On the other hand, since the FM sideband corresponds to a vibration frequency of the object, it is possible to measure the vibration of the object by performing FM demodulation on the beat signal obtained by the interference. It should be noted that “FM” means frequency modulation.

As described above, with the measurement system according to the first aspect, it is possible to measure the three-dimensional shape and measure the vibration of the object. In this case, since the laser light source that outputs the FMCW laser light is used as a light source for three-dimensional shape measurement and a light source for vibration measurement, it is possible to prevent the system from becoming large-scale by simply combining the two systems.

As described above, with the measurement system according to the first aspect, it is possible to measure the three-dimensional shape and the vibration of the object with a simple configuration.

It should be noted that the three-dimensional shape and the vibration can be used to grasp the state (presence or absence of damage, degree, and the like) of the object.

In the first aspect and each of the following aspects, the “frequency-modulated continuous wave laser” (hereinafter, may be referred to as “FMCW laser”) is laser light that transmits a frequency-modulated continuous wave, and a distance can be obtained from a frequency difference (beat frequency) between a transmission wave and a reflected wave. In the measurement using the frequency-modulated continuous wave laser light, the distance resolution is determined by the frequency change.

It should be noted that, in the first aspect and each of the following aspects, the three-dimensional shape measurement and the vibration measurement may be performed at the same time or in parallel, or may be performed separately.

It should be noted that, in the first aspect, the excitation source in the vibration measurement may or may not be present. Even in a case in which there is no vibration by the excitation source, the natural vibration of the object or the normal vibration (the vibration of the road or the bridge on which the vehicle is always traveling, the vibration of the continuously operating device, and the like) due to use can be measured.

A second aspect provides the measurement system according to the first aspect, in which the laser light source outputs frequency-shifted feedback laser light as the frequency-modulated continuous wave laser light. The second aspect defines a specific aspect of the “frequency-modulated continuous wave laser”, and the “frequency-shifted feedback laser” (hereinafter, may be referred to as an FSF laser) is a laser having a configuration in which an output of a frequency shifter (first diffracted light of an acousto-optic element and the like) is fed back to a gain medium, and is a type of the frequency-modulated continuous wave laser.

A third aspect provides the measurement system according to the second aspect, further comprising: an excitation sound source that irradiates the object with sound to excite vibration, in which the vibration measurer measures the vibration of the object subjected to the excitation. The third aspect defines an example of the excitation sound source, and, for example, a directional speaker can be used as the excitation sound source.

A fourth aspect provides the measurement system according to the third aspect, further comprising: a region setting unit that sets an acoustic irradiation region to be irradiated with the sound, in which the excitation sound source irradiates the set acoustic irradiation region with the sound. According to the fourth aspect, it is possible to irradiate (excite) a desired region with the sound. A partial region of the object is irradiated with the sound. Further, the region setting unit may set the acoustic irradiation region based on a user instruction or may set the acoustic irradiation region without depending on the user instruction.

A fifth aspect provides the measurement system according to the fourth aspect, in which the region setting unit extracts candidate regions as candidates of the acoustic irradiation region based on the measured three-dimensional shape, and displays the extracted candidate regions on a display device. The fifth aspect defines an aspect of the candidate region extraction and display.

A sixth aspect provides the measurement system according to the fifth aspect, in which the region setting unit extracts, as the candidate regions, a region in which a fluctuation from design information of the three-dimensional shape of the object and/or a measurement result of the three-dimensional shape acquired in advance exceeds a reference. The sixth aspect specifically defines an aspect of the extraction of the candidate region. As the “design information”, for example, information based on computer-aided design (CAD) data of the object can be used, and in this case, the region setting unit can extract a region in which a deviation from the design value exceeds the reference as the candidate region. In addition, as the “measurement result of the three-dimensional shape acquired in advance”, for example, a previous measurement result can be used, and in this case, the region setting unit can extract a region in which a deviation from the previous measurement result exceeds the reference as the candidate region.

It should be noted that, in the sixth aspect, the region setting unit may predict a fluctuation of the three-dimensional shape in a predetermined period based on the previous measurement result, and extract a region in which a prediction result after the predetermined period has elapsed exceeds a reference as the candidate region.

A seventh aspect provides the measurement system according to any one of the first to sixth aspects, in which the shape measurer measures the three-dimensional shape of the object based on the center frequency of the beat signal obtained by irradiating the object with the frequency-modulated continuous wave laser light at a first pitch, and the vibration measurer measures the vibration of the object based on the FM sidebands obtained by irradiating the object with the frequency-modulated continuous wave laser light at a second pitch larger than the first pitch. In a case in which the vibration measurement for a certain region takes longer time than the distance measurement (three-dimensional shape measurement) for a region having the same width, the pitch of the vibration measurement can be made larger than the pitch of the distance measurement as in the seventh aspect.

An eighth aspect provides the measurement system according to any one of the first to seventh aspects, in which the laser scanner includes a first laser scanner and a second laser scanner, both of which are supplied with the frequency-modulated continuous wave laser light, the shape measurer measures the three-dimensional shape of the object based on the center frequency of the beat signal obtained by the first laser scanner, and the vibration measurer measures the vibration of the object based on the FM sidebands obtained by the second laser scanner. As described above, the laser light sources are common in the embodiment of the present invention, but as defined in the eighth aspect, the scanner for three-dimensional shape measurement and the scanner for vibration measurement may be separate from each other. Such a configuration can be adopted in response to a request for a scanning speed or a scanning range of the three-dimensional shape measurement and the vibration measurement.

A ninth aspect provides the measurement system according to the eighth aspect, further comprising: a branch device that branches the frequency-modulated continuous wave laser light, and supplies the branched frequency-modulated continuous wave laser light to the first laser scanner and the second laser scanner. As described above, since the laser light source is common to the three-dimensional shape measurement and the vibration measurement, in a case in which a plurality of scanners are provided, the laser light is branched and supplied.

A tenth aspect provides the measurement system according to any one of the first to ninth aspects, further comprising: an evaluator that evaluates delamination of the object based on the measured vibration.

An eleventh aspect provides the measurement system according to any one of the first to tenth aspects, further comprising: a display control unit that displays the measured three-dimensional shape and the measured vibration in association with each other on a display device. According to the eleventh aspect, the user can easily grasp the measurement result visually. The display can be performed by, for example, a character, a number, a symbol, a graph, a table, an image, and the like, and colors may be added thereto. For example, the measurement result of the three-dimensional shape and the measurement result of the vibration may be displayed in a superimposed manner (it is conceivable to perform a contour line or pseudo-color expression of the vibration). In addition, in a case in which the delamination is evaluated, the display control unit may display the evaluation result of the delamination in association with the three-dimensional shape and/or the vibration.

A twelfth aspect provides the measurement system according to any one of the first to eleventh aspects, in which the laser scanner performs the scanning on a measurement object, including any of a concrete structure, a metal member, or a plastic member, as the object. The “object” in the embodiment of the present invention is, for example, social infrastructure structures such as a road, a bridge, a tunnel, a dam, and a building, for example, a concrete structure, but is not limited thereto, and may be a metal member or a plastic member as defined in the twelfth aspect. In addition, the structure may be a structure in which the concrete structure is combined with the metal member or the plastic member.

As described above, with the measurement system according to the embodiment of the present invention, it is possible to measure the three-dimensional shape and the vibration of the object with a simple configuration.

### BRIEF DESCRIPTION OF THE DRAWINGS

FIG. 1 is a diagram showing a principle of an LDV of a pseudo heterodyne method.

FIGS. 2A and 2B are diagrams showing an example of a laser-driven waveform and an example of a beat frequency of interference light.

FIG. 3 is a conceptual diagram showing a configuration of a measurement system according to Example 1.

FIG. 4 is a diagram showing a center frequency and a vibration frequency of a beat signal.

FIG. 5 is a diagram showing a state of signal processing in a frequency-shifted feedback laser.

FIG. 6 is a diagram showing acquisition of three-dimensional point cloud data by scanning.

FIGS. 7A to 7C are diagrams showing detection of a vibration component by an FM receiver.

FIG. 8 is a diagram showing the beat signal in a case in which an object is not vibrating.

FIG. 9 is a conceptual diagram showing a configuration of a measurement system according to Example 2.

FIGS. 10A and 10B are diagrams showing a relationship between a shape measurement point and a vibration measurement point.

FIGS. 11A and 11B are diagrams showing a state in which candidate regions for acoustic excitation are extracted and set based on a shape measurement result.

FIG. 12 is a diagram showing an example of a vibration measurement result.

FIG. 13 is a conceptual diagram showing a configuration of a measurement system according to Example 3.

FIG. 14 is a conceptual diagram showing a configuration of a measurement system according to Example 4.

FIG. 15 is a conceptual diagram showing a configuration of a measurement system according to Example 5.

FIG. 16 is a diagram showing a state of three-dimensional shape measurement using a laser.

FIG. 17 is a diagram showing a state of non-contact acoustic inspection.

### DESCRIPTION OF THE PREFERRED EMBODIMENTS

### Principle of Laser Doppler Vibrometer of Pseudo Heterodyne Method

The principle of a laser Doppler vibrometer (LDV) of a pseudo heterodyne method will be described. It should be noted that the FMCW method is almost the same as the pseudo heterodyne method, and the following principle also applies to the vibration measurement of the FMCW method.

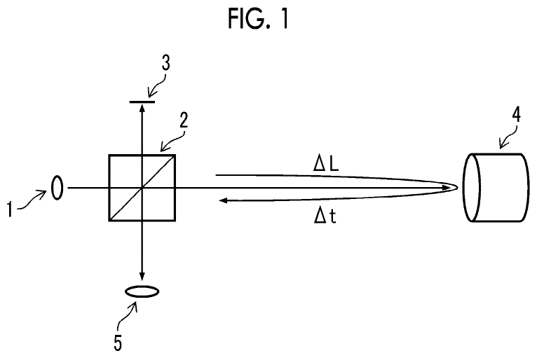

FIG. 1 is a diagram showing the principle of the LDV of the pseudo heterodyne method. Laser light output from a laser light source 1 is branched into reference light and object light by a half mirror 2. The reference light is reflected by a reference mirror 3, the object light is reflected by a measurement object 4, and the reference light and the object light are incident on a light receiver 5 via the half mirror 2, so that the reference light and the object light interfere with each other. It is assumed that a round trip distance of the object light (optical path difference with the reference light) is ΔL and a round trip time (flight time difference with the reference light) is Δt.

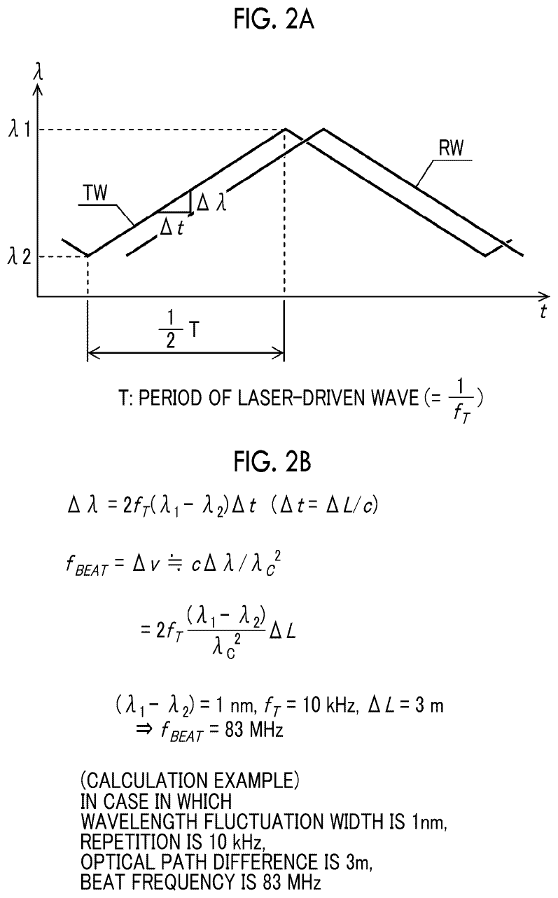

FIGS. 2A and 2B are diagrams showing an example of a laser-driven waveform and a numerical example of a beat frequency of interference light. FIG. 2A shows an example of the laser-driven waveform. In the example shown in FIG. 2A, a transmission wave TW is a triangular wave in which a wavelength changes in a range from λ₁ to λ₂ with a period T, and a reception wave RW changes in the same pattern with a delay of Δt (the above-described round trip time) from the transmission wave TW. In a case of focusing on a certain time, a difference in wavelength between the transmission wave TW and the reception wave RW is Δλ.

FIG. 2B shows the numerical example of the beat frequency of the interference light. As shown in the expression of FIG. 2B, as an example, in a case in which a wavelength fluctuation width (λ₁-λ₂) of a laser-driven wave is set to 1 nm, a frequency f_{T} (=1/T) of the laser-driven wave is set to 10 kHz, and a wavelength λ_{c} of the laser light before modulation is set to 850 nm (near-infrared laser), a frequency f_{BEAT} of a beat signal of the laser-driven wave is 83 MHz.

The LDV of the pseudo heterodyne method is also described in, for example, the following non-patent document 1.

[Non-Patent Document 1] “Pseudoheterodyne detection scheme for optical interferometers”, D. Jackson, A. Kersey et al., Electronics Letters pp. 1082-1083, vol. 18, No.25, 1982.

In the above-described non-patent document 1, the optical path difference is about several cm, and the beat frequency is 20 kHz. Meanwhile, in a case of non-contact measurement of a social infrastructure structure such as a concrete structure, the distance is long, and thus the beat frequency is on the order of MHz as in the above-described example, which is extremely high as compared with the example of the non-patent document 1. Therefore, it is difficult to simply apply the method of the non-patent document 1 to the measurement of the social infrastructure structure.

### Distance Measurement and Vibration Measurement Using Frequency-Shifted Feedback Laser

The optical distance measurement using a frequency-shifted feedback (FSF) laser is described in, for example, the following non-patent document 2. In the non-patent document 2, a method (optical frequency domain reflectometry (OFDR)) of measuring a distance by converting the distance into a frequency using frequency-chirped light is described.

[Non-Patent Document 2] “Frequency-shifted feedback laser and Measurement Application”, Koichiro Nakamura et al., [Searched on Jan. 24, 2023], Internet (https://www.jstage.jst.go.jp/article/lsj1973/27/Supplement/27_Supplement_114/_pdf/-char/ja)

Further, the vibration measurement by the FSF laser distance meter is described in, for example, the following non-patent document 3.

[Non-Patent Document 3] “Vibration measurement with frequency-shifted feedback laser”, Takefumi Hara, Optical and electro-optical engineering contact, August 2017, Japan Optomechatronics Association, [Searched on Jan. 24, 2023], Internet (http://www.joem.or.jp/2017-8-4.pdf)

In the non-patent document 3, focusing on a time response of the center frequency of the beat signal itself, a target of measurement is vibration at low frequencies on the order of up to several tens of Hz. Therefore, it is difficult to apply the technology of the non-patent document 3 to the measurement of the social infrastructure structure such as a concrete structure, in which vibration at a high frequency (for example, the above-described vibration of the kHz order) is assumed. In contrast to such a technology of the related art, in the present invention, FM sidebands (FM sideband waves) of the beat frequency are detected to measure the vibration (details will be described later).

### Example of Measurement System According to Embodiment of Present Invention

Examples of the measurement system according to the embodiment of the present invention will be described in detail.

### Example 1

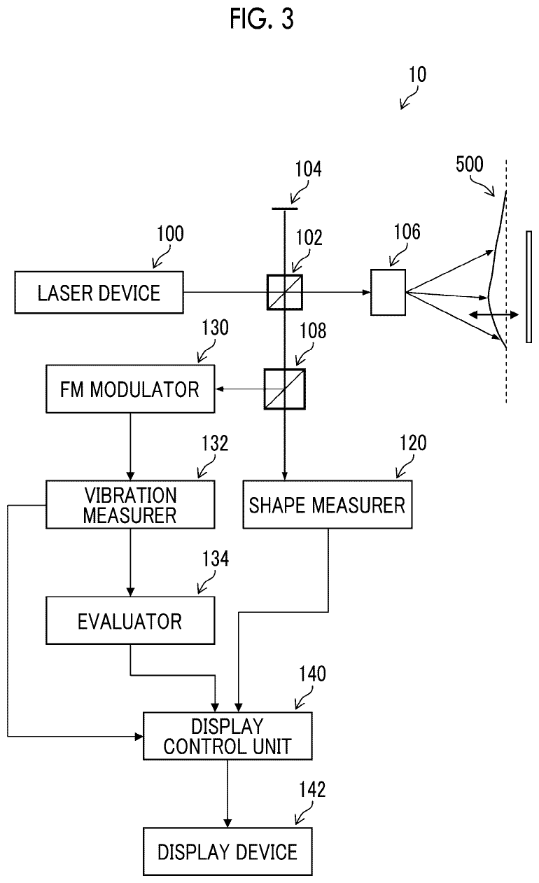

FIG. 3 is a conceptual diagram showing a configuration of a measurement system 10 (measurement system) according to Example 1. The measurement system 10 includes a laser device 100 (laser light source and interferometer). The laser device 100 comprises a laser light source that outputs the frequency-shifted feedback laser light (FSF laser light) and a control unit of the laser light source. The laser light source includes a laser medium, a mirror, an acousto-optic modulator (AOM), and the like, but as described in JP2021-096383A, a light single side band (SSB) modulator may be used as the frequency shifter. The FSF laser light output from the laser device 100 is split into the reference light and the measurement light by the half mirror 102 (interferometer), and the reference light is reflected by a reference mirror 104 (interferometer). It should be noted that, hereinafter, a case will be described in which the laser device 100 outputs the frequency-shifted feedback laser light (FSF laser light), but the laser light used in the present invention may be frequency-modulated continuous wave laser light (FMCW laser light) other than the FSF laser light. In addition to the FSF laser light, frequency-modulated continuous wave laser light may be generated using by a distributed feedback (DFB) semiconductor laser, a Fabry-Perot type semiconductor laser, a surface-emitting semiconductor laser, or the like. For example, in a case in which a drive current waveform of the semiconductor laser is controlled by a sawtooth wave or a triangular wave, the frequency changes in accordance with the change in the current, so that the semiconductor laser operates as the frequency-modulated continuous wave laser.

A laser scanner 106 (laser scanner, interferometer) scans an object 500 (object, measurement object) with the FSF laser light. That is, the laser scanner 106 irradiates a measurement target region of the object 500 with the laser light while changing a scanning direction. By mixing the reflected light reflected by the object 500 with the reference light using the half mirror or the like, the interference between the reference light and the reflected light occurs.

The combined reference light and reflected light are split into two beams by the half mirror 108 (beam splitter). One beam is input to a shape measurer 120 (shape measurer) to perform three-dimensional shape measurement, and the other beam is input to a vibration measurer 132 (vibration measurer) to perform vibration measurement. A display control unit 140 (display control unit) can display a measurement result of the three-dimensional shape, a measurement result of the vibration, and the like on a display device 142 (display device) (details will be described later).

It should be noted that, in Example 1 and other examples described later, functions of a signal processing unit, a region setting unit, a display control unit, an FM demodulator, a vibration measurer, an evaluator, and the like, which constitute the measurement system, can be realized by a processor such as a central processing unit (CPU), a field programmable gate array (FPGA), and a programmable logic device (PLD), and/or various electric circuits. In a case of processing by each of these units, a program or data recorded on a non-transitory and tangible recording medium (not shown) such as a read-only memory (ROM) or a flash ROM can be used, and a recording medium (not shown) such as a random-access memory (RAM) can be used as a work area or a temporary data recording area during processing. It should be noted that the “non-transitory and tangible recording medium” described above does not include a non-tangible recording medium such as a carrier wave signal itself and a propagation signal itself.

The measurement system 10 comprises an operation unit (keyboard, mouse, and the like) (not shown) in addition to the above-described elements, and the user can issue an instruction on the measurement or result display via the operation unit. In addition, the measurement system 10 comprises a recording device (magneto-optical recording device, semiconductor memory, and the like, which are non-transitory and tangible recording media, and control unit thereof) (not shown), and can record scan data and measured data in the recording device. The measurement system 10 may perform the measurement, the evaluation, or the prediction using the data recorded in the recording device. These points are also the same in other examples described later.

In Example 1, the object 500 may be a concrete structure such as a road, a bridge, a tunnel, or a building, but the object to be measured in the embodiment of the present invention is not limited to the concrete structure, and may include a metal member, a plastic member, or two or more of concrete, metal, or plastic (the same applies to other examples described later).

### Measurement of Distance and Vibration Based on Beat Signal

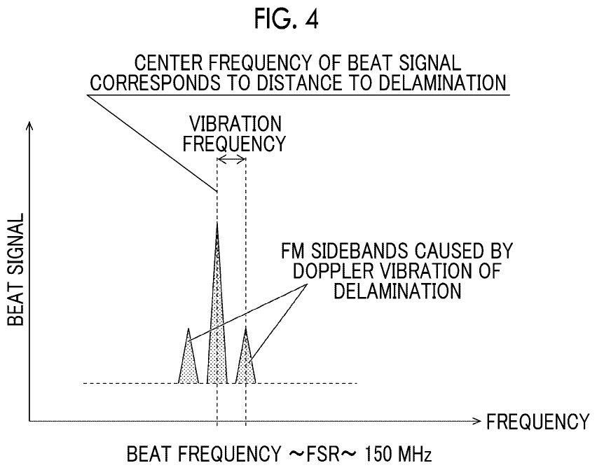

The principle of the measurement based on the beat signal of the interfered light will be described. FIG. 4 is a conceptual diagram showing the beat signal. The center frequency of the beat signal corresponds to the distance to a measurement point (a portion in which delamination occurs, and the like), and there is a relationship of “in a case in which the center frequency is low, the distance to the measurement point is short, and in a case in which the center frequency is high, the distance is long”. Specifically, according to the non-patent document 4, the beat frequency and the distance (strictly speaking, the optical path difference) are in a proportional relationship in distance measurement (optical frequency domain reflectometry: OFDR) using frequency-chirped light as in Expression (1). Here, v_{Bm} is an m-th beat frequency, γ is a chirp rate, nL is an optical path difference of the interferometer, c₀ is a speed of light in vacuum, v_{c} is a frequency spacing of a resonator, and an integer m is a difference in comb number between optical waves that interfere with each other at the beat order. It should be noted that the second term of Expression (1) is known by a degree discrimination.

$${v}_{B m} = γ \frac{n L}{{C}_{0}} - m {ν}_{C} \qquad ( 1 )$$

[Non-Patent Document 4] “Ultrahigh-accuracy optical measurement technology with frequency-shifted feedback laser”, Takefumi Hara et al., JSAP International, Vol. 74, No. 6, pp. 697-702, Jun. 10, 2005

As described above, the three-dimensional shape can be measured by repeating the distance measurement based on the center frequency.

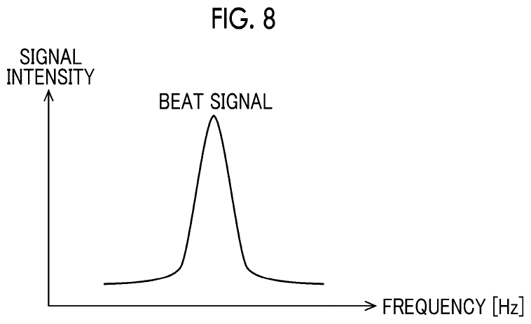

Meanwhile, whether or not the FM sidebands of the beat signal are generated depends on the presence of delamination. The FM sidebands are not generated in a case in which there is no delamination (see FIG. 8 described later), and the FM sidebands are generated in a case in which there is delamination. In addition, the difference between the center frequency of the beat signal and the frequency of the FM sideband corresponds to the vibration frequency of delamination. As described above, the vibration or the delamination of the object can be evaluated based on the presence or absence and the degree of the sidebands.

It should be noted that the measurement system according to Example 1 does not have the excitation sound source as in Examples 2 to 5 described below, but the natural vibration of the object 500 can be measured even in such a configuration. The “natural vibration” referred to here is a vibration that occurs due to normal use or operation of the object, and specifically, for example, a vibration of a road or a bridge on which a vehicle continuously passes, a continuously operating device, or the like.

### Measurement Principle of Three-Dimensional Shape

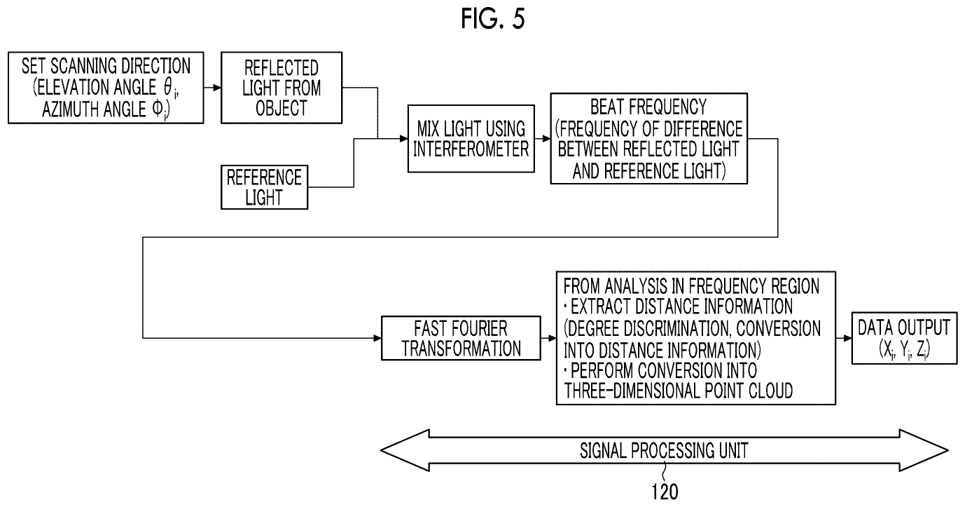

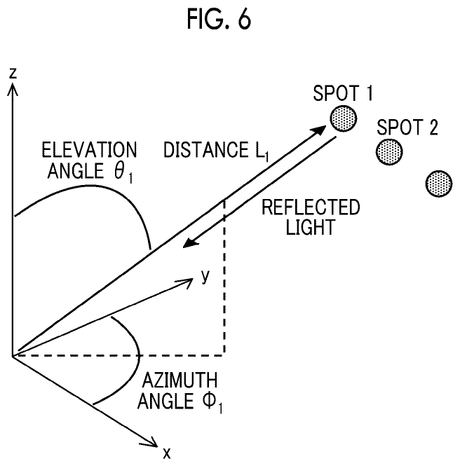

FIG. 5 is a diagram showing the measurement principle of the three-dimensional shape, and FIG. 6 is a diagram showing a state of the acquisition of three-dimensional point cloud data by scanning.

In a case in which the laser scanner 106 emits the laser light that is frequency modulated in the scanning direction (elevation angle θᵢ and azimuthal angle ϕᵢ), a spot i (i=1, 2, . . . ) is formed on the object. The reflected light from the spot i and the reference light are mixed (interfered) with each other to generate the beat signal. The shape measurer 120 (shape measurer) can calculate the distance Lᵢ in the scanning direction (elevation angle θᵢ and azimuthal angle ϕᵢ) from the component of the center frequency of the beat signal by performing fast Fourier transformation (FFT) on the beat signal. The laser scanner 106 sequentially changes the scanning direction, and thus the shape measurer 120 obtains a data set (elevation angle θᵢ, azimuthal angle ϕᵢ, distance Lᵢ: i=1, 2, . . . ) of the direction and the distance at each spot (see FIG. 6). In addition, the shape measurer 120 can convert the distance Lᵢ and the scanning direction (elevation angle θᵢ and azimuthal angle ϕᵢ) into a three-dimensional point cloud (Xᵢ, Yᵢ, Zᵢ) by the following Expression (2), and thus can measure the three-dimensional shape of the object 500.

$${X}_{i} = {L}_{i} \times sin {Θ}_{i} \times cos {Φ}_{i} {Y}_{i} = {L}_{i} \times sin {Θ}_{i} \times sin {Φ}_{i} {Z}_{i} = {L}_{i} \times cos {Θ}_{i} \qquad ( 2 )$$

### Extraction of Vibration Component by FM Demodulation

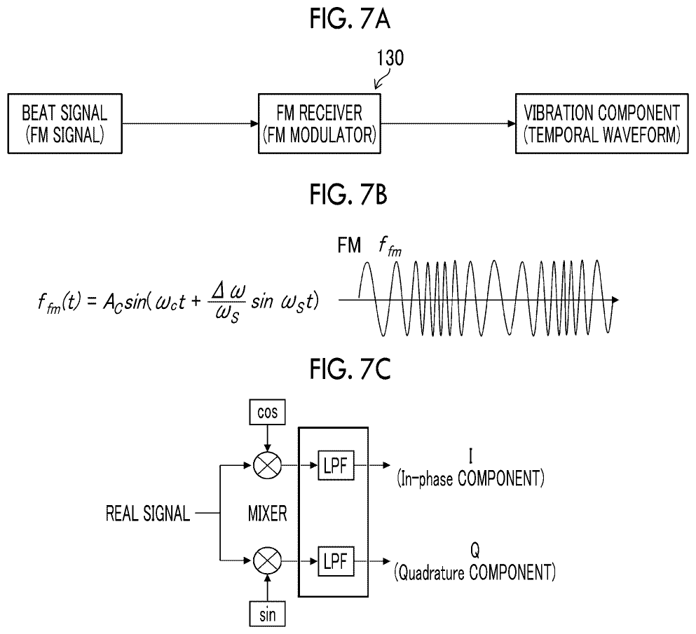

FIGS. 7A to 7C are diagrams showing the extraction of the vibration component by the FM demodulation. FIG. 7A shows processing of extracting the vibration component (temporal waveform) from the beat signal. As shown in FIG. 8, in the beat signal in a case in which the object is not vibrating, the beat signal has only a peak (center frequency), but in a case in which the object is vibrating, sideband waves having a beat frequency as a carrier wave are generated on both sides of the center frequency (see FIG. 4). As a result, an FM signal (frequency-modulated signal) as shown in FIG. 7B is obtained.

### FM Demodulation (Detection of Sidebands)

An FM demodulator 130 (FM receiver) performs FM demodulation on the beat signal obtained by the interference to detect the FM sidebands. The demodulation can be performed by a plurality of stages such as a quadrature demodulator, a PLL demodulator (PLL: phase locked loop), and a digital demodulator. FIG. 7C is a block diagram of a quadrature detector (quadrature demodulator) that is one aspect of the FM demodulator. The quadrature detector discriminates the amplitude and the phase of the signal independently based on an orthogonal relationship between a real part and an imaginary part of an analysis signal (complex signal) generated from a real signal. Specifically, the amplitude and the phase can be calculated from an in-phase component (I component) and a quadrature component (Q component) obtained by mixing (multiplying) two orthogonal signals (a sin wave and a cos wave) with a mixer into the real signal and passing the real signal through a low-pass filter (LPF). As a result, the vibration component (amplitude and frequency of a sinusoidal waveform) can be extracted. It should be noted that, although the quadrature detection can be performed using a Hilbert filter, it is easier to realize the LPF than the Hilbert filter.

It should be noted that the vibration measurer 132 may include a circuit (addition circuit, LPF, and the like) for extracting the amplitude and the phase from the I component and the Q component.

### Relationship between Vibration and Delamination

An evaluator 134 (evaluator) can evaluate the delamination of the object based on the vibration component measured by the above-described method (that is, based on the presence or absence of the FM sidebands and the size of the FM sidebands). It should be noted that, as described in the following non-patent document 5, in a case in which it is assumed that the cracking completely appears, the natural frequency ffr of the deflection vibration is represented by the following Expression (3).

[Non-Patent Document 5] “Research and development on non-contact acoustic inspection method for non-destructive inspection”, Tsuneyoshi Sugimoto et al., Report on the results of technological research and development contributing to the improvement of road policy quality No. 22-3, Road and Street Policy Improvement, July 2014, [Searched on Jan. 24, 2023], Internet (https://www.mlit.go.jp/road///tech/jigo/h22/pdf/report22-3.pdf)

$${f}_{fr} = \frac{4.98}{2 π {a}^{2}} \sqrt{\frac{{Eh}^{2}}{12 ρ ( 1 - {v}^{2} )}} \qquad ( 3 )$$

Here, h is a depth from concrete to a defect, a is a radius, E is a Young's modulus, vis a Poisson's ratio, and ρ is a density. From Expression (3), it can be understood that the natural frequency is proportional to the depth of the defect and is inversely proportional to the square of the radius (corresponding to the area).

It should be noted that, in a case in which the object is a concrete structure, the actual vibration frequency is about several hundred Hz to 10 kHz due to the physical properties of the concrete.

### Relationship between Progression of Delamination and Vibration Frequency

In the initial stage of delamination, it is assumed that, since cracking incompletely appears, the vibration frequency at which the cracking is appropriately exhibited cannot be obtained (the above-described proportional relationship does not hold with high accuracy), and the signal is weak. It is considered that the vibration frequency can be clearly obtained and the vibration signal is also remarkably expressed as the delamination progresses.

### Characteristics of Measurement in Example 1

[Relationship between Processing Speed of Shape Measurement and Processing Speed of Vibration Measurement]

In a case in which the shape and the vibration are measured by the above-described method, it is considered that the measurement of the vibration takes longer time than the measurement of the three-dimensional shape. Therefore, in a case in which the scanning is performed in accordance with the processing speed required for the shape measurement (high-speed scanning is required in order to measure a wide range), there is a possibility that the vibration measurement processing cannot keep up with the scanning speed. In response to this point, for example, the following countermeasures can be considered.

### (1) Countermeasure 1: Executing Scanning for Shape Measurement and Scanning for Vibration Measurement

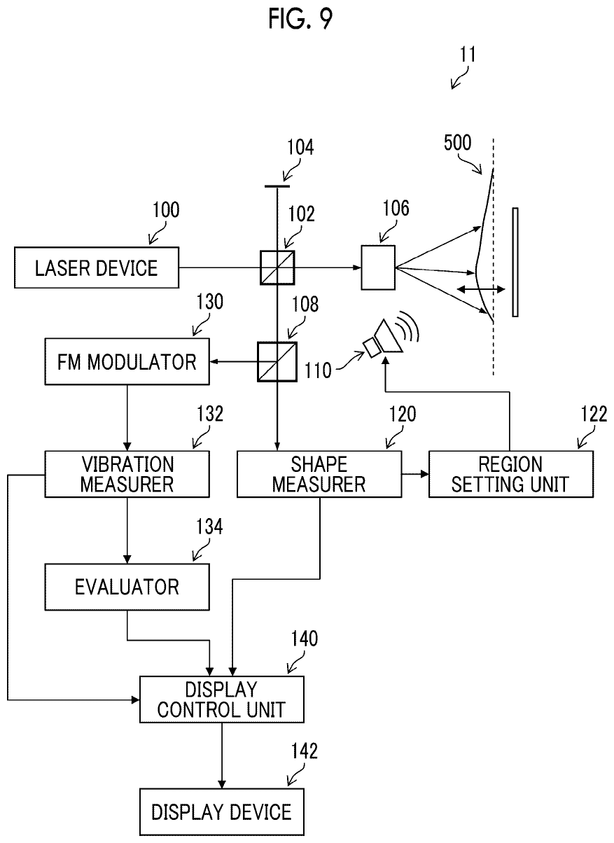

The three-dimensional shape is measured with data obtained by the first scanning, a region in which delamination or the like is likely to occur is identified, and the region is scanned again to measure the vibration. In this case, the FM demodulation need not be performed in the first scanning. It should be noted that, in this case, the measurement system 10 may comprise a region setting unit 122 (region setting unit: see Example 2 and FIG. 9 to be described later).

### (2) Countermeasure 2: Thinning Out Scan Data to Perform Vibration Measurement

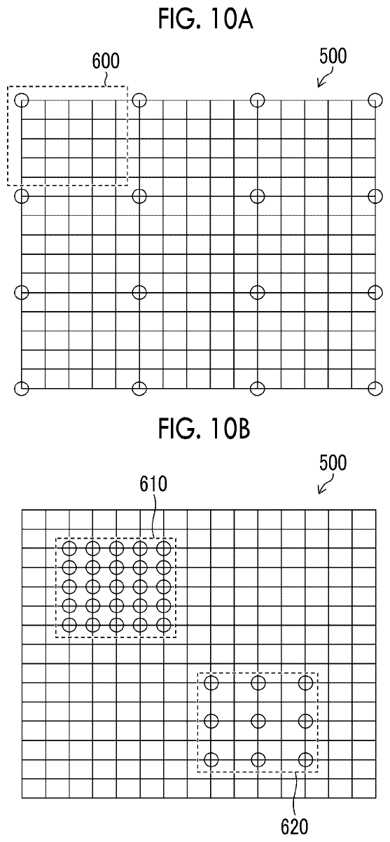

The scanning is performed once. The three-dimensional shape is measured using all data, and the vibration is measured (delamination is evaluated) using a part of data obtained by thinning out the data. In this case, by making a pitch of the vibration measurement larger than a pitch of the shape measurement, the two measurements can be performed at the same time (in parallel) (see Example 2 and FIGS. 10A and 10B described later).

### (3) Countermeasure 3: Accumulating Data and Performing Post-Processing

The scanning is performed once. The three-dimensional shape is measured using all data, and the scan data is accumulated. The vibration is measured in the post-processing by using the accumulated data.

According to Example 1 of the above-described configuration, the three-dimensional shape and the vibration of the object can be measured with a simple configuration by sharing the FSF laser light source (FMCW laser light source) between the three-dimensional shape measurement and the vibration measurement.

### Example 2

FIG. 9 is a diagram showing a configuration of a measurement system according to Example 2. A measurement system 11 according to Example 2 comprises an excitation sound source 110 (excitation sound source), and can irradiate the object 500 with sound to excite the object 500. As the excitation sound source 110, a device such as a long-range acoustic device (LRAD) can be used, and thus an acoustic pressure of, for example, about 100 dB can be applied to the object 500 from a point separated by about 10 m. In addition, the measurement system 11 comprises a region setting unit 122 (region setting unit) that sets an acoustic irradiation region, and the excitation sound source 110 irradiates the set acoustic irradiation region with sound. It should be noted that other configurations of the measurement system 11 are the same as those of the measurement system 10 according to Example 1, and thus the detailed description thereof will be omitted.

### Example 2: Measurement Using Excitation Sound Source

In Example 2, the non-contact acoustic inspection using the excitation sound source 110 can be performed in addition to the three-dimensional shape measurement. The vibration measurer 132 can measure the vibration of the object 500 excited by the sound emitted by the excitation sound source 110. It should be noted that, in Example 2, the same problem as in Example 1 occurs with respect to the scanning speed, and thus it is possible to take countermeasures such as the above-described countermeasures 1 to 3 and the like.

FIGS. 10A and 10B are diagrams showing an example of a relationship between the pitch of the shape measurement and the pitch of the vibration measurement (lattice points are shape measurement points, and circles are vibration measurement points). FIG. 10A shows an example (corresponding to the above-described countermeasure 2) in which the scanning is performed once, the pitch (second pitch) of the vibration measurement is set to be larger than the pitch (first pitch) of the shape measurement, and the vibration measurement is performed on a wide range of the object 500 (for example, the entire object 500). In this example, as shown in a unit region 600, a ratio between the vibration measurement and the shape measurement is 1:25.

On the other hand, FIG. 10B shows an example (corresponding to the above-described countermeasure 1) in which the non-contact acoustic inspection is performed based on the result of the three-dimensional shape measurement. In this example, the shape measurer 120 measures the three-dimensional shape using the data obtained by the first scanning, and the region setting unit 122 extracts the candidate regions that are the candidates of the acoustic irradiation region based on the measured three-dimensional shape. The candidate region is, for example, a region in which damage such as delamination has occurred, or a partial region of the object 500 in which the degree of damage is high or damage is considered to be progressing. The pitch of the acoustic inspection may be the same as the pitch of the shape measurement as shown in a unit region 610, or may be larger than the pitch of the shape measurement as shown in a unit region 620.

### [Extraction of Candidate Region and Setting of Acoustic Irradiation Region]

The region setting unit 122 can calculate a fluctuation of the measured three-dimensional shape from the design information of the three-dimensional shape of the object 500 (object) and/or the measurement result of the three-dimensional shape acquired in advance, and extract a region in which the magnitude of the fluctuation exceeds a reference as the candidate region. As the “design information”, for example, three-dimensional data generated from CAD data or the like can be used, and as the “measurement result acquired in advance”, a previous measurement result can be used. In addition, the “reference” is, for example, a threshold value of the fluctuation, and a threshold value set by the user may be used. In addition, the display control unit 140 can display the extracted candidate region or the set acoustic irradiation region on the display device 142 (display device).

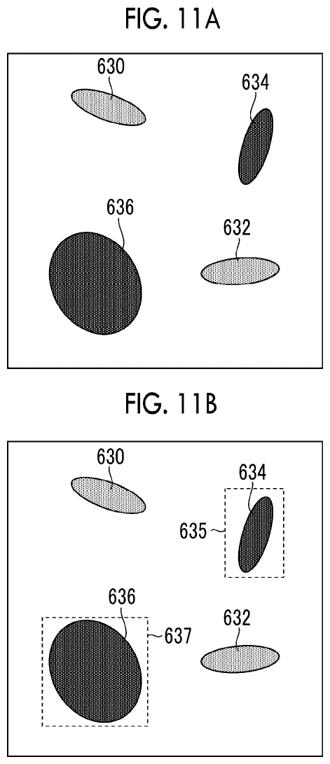

FIGS. 11A and 11B are diagrams showing a state of the display of the candidate region and the acoustic irradiation region. FIG. 11A is a display example of the magnitude of the fluctuation in the three-dimensional shape (the fluctuation from the design information of the three-dimensional shape and/or the measurement result of the three-dimensional shape acquired in advance). In the diagram, the color depth indicates the magnitude of the fluctuation. The darker the color, the greater the fluctuation, and the fluctuation in regions 634 and 636 is greater than that in regions 630 and 632. In such a diagram, the region setting unit 122 and the display control unit 140 can superimpose the magnitude of the fluctuation based on the measurement and the image or the design information of the object 500 and associate (correspond) both with each other. It should be noted that the region setting unit 122 and the display control unit 140 may display the magnitude of the fluctuation in the chroma saturation in addition to or instead of the color depth, or may display the color depth in combination with a character, a number, a figure, a symbol, a graph, or the like.

The user can determine the acoustic irradiation region with reference to the displayed shape measurement result and can issue an instruction to set the acoustic irradiation region via an operation unit (not shown). That is, the magnitude of the fluctuation can be easily grasped visually, and the instruction for setting the appropriate acoustic irradiation region can be issued. FIG. 11B is an example of acoustic irradiation regions 635 and 637 (rectangular portions indicated by dotted lines) indicated by the user.

The region setting unit 122 sets the acoustic irradiation region based on the instruction from the user, the excitation sound source 110 irradiates the acoustic irradiation region with the sound, and the vibration measurer 132 measures the excited vibration. It should be noted that the region setting unit 122 can set the acoustic irradiation region based on the instruction from the user, but may automatically set the acoustic irradiation region based on the shape measurement result. The region setting unit 122 can set, for example, a region including a region in which the magnitude of the fluctuation is equal to or greater than the threshold value, as the acoustic irradiation region.

### [Display Example of Vibration Measurement Result]

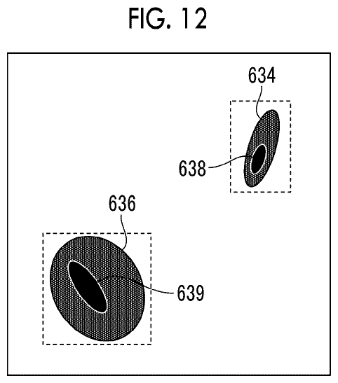

The display control unit 140 can superimpose the measurement result by the vibration measurer 132 and the image or the design information of the object 500, and associate (correspond) both with each other. For example, the image or design information of the object 500 can be displayed on the display device 142 by adding the characters, numbers, symbols, figures, colors, and the like in accordance with the level of the frequency of the vibration and/or the magnitude of the amplitude. The display control unit 140 can display, for example, as shown in FIG. 12, a region having a high vibration frequency or a region having a large vibration (in the example of FIG. 12, regions 638 and 639) in a dark color.

Further, the evaluator 134 can evaluate the delamination or the peeling based on the measurement result of the vibration, as in Example 1. The evaluator 134 and the display control unit 140 may display the display result on the display device 142 or may record the display result in the recording device.

The display control unit 140 may display the measurement results of the shape and the vibration, and the evaluation results of the delamination or the peeling on the display device 142 in time series by a chart, a graph, or the like, or may display the prediction results based on the previous measurement results. The shape measurer 120 and the vibration measurer 132 may extrapolate the previous measurement result with a linear or non-linear function to predict the shape change, the vibration, and the delamination (damage), or may perform the prediction using a predictor constructed by machine learning or a prediction model constructed by other methods. Such prediction can be reflected in the evaluation of damage such as delamination, and the planning of the inspection, the repair, and the like.

According to Example 2 of the above configuration, it is possible to measure the three-dimensional shape and the vibration of the object with a simple configuration, as in Example 1.

### Example 3

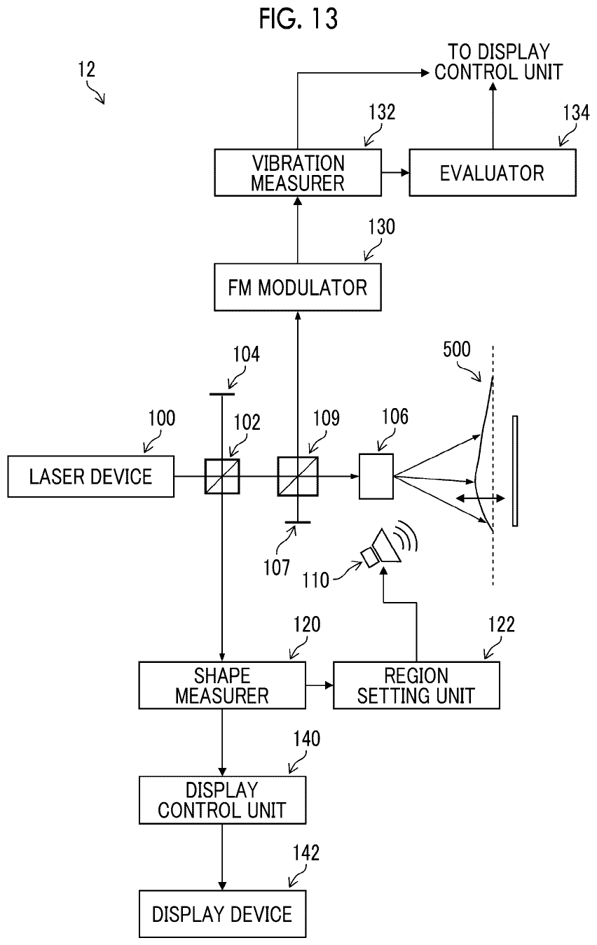

FIG. 13 is a diagram showing a configuration of a measurement system 12 (measurement system) according to Example 3. In the measurement system 12, the laser scanner 106 is shared between the three-dimensional shape measurement and the vibration measurement as in Examples 1 and 2, while the interferometers are different between the three-dimensional shape measurement and the vibration measurement. Specifically, the reference light and the reflected light from the reference mirror 104 (interferometer) are used for the three-dimensional shape measurement, and the reference light and the reflected light from a reference mirror 107 (interferometer) are used for the vibration measurement. A half mirror 109 branches the reflected light and supplies the branched light to a three-dimensional measurement system and a vibration measurement system. Since other configurations are the same as those in Examples 1 and 2, the detailed description thereof will be omitted.

In Example 3 having the above-described configuration as well, the three-dimensional shape measurement, the vibration measurement, and the evaluation of delamination can be performed in the same manner as in Examples 1 and 2. That is, it is possible to measure the three-dimensional shape and the vibration of the object with a simple configuration. In addition, the measurement system 12 according to Example 3 has a feature in that the SN ratio of the vibration measurement is high because the light received by the laser scanner 106 passes through the half mirror (half mirror 109 and half mirror 102) twice until the light is input to the shape measurer 120, whereas the light input to the vibration measurer 132 passes through the half mirror (half mirror 109) only once. Regarding the point that scanning is quick in the vibration measurement, it is possible to take countermeasures as described above in Examples 1 and 2.

### Example 4

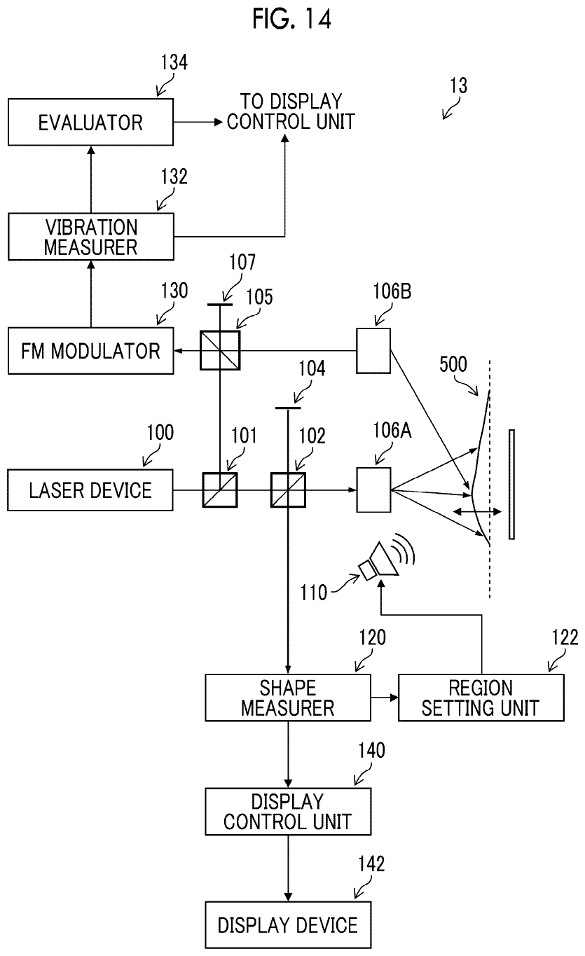

FIG. 14 is a diagram showing a configuration of a measurement system 13 (measurement system) according to Example 4. The measurement system 13 comprises a laser scanner 106A (first laser scanner) for shape measurement and a laser scanner 106B (second laser scanner) for vibration measurement, and the frequency-shifted feedback laser light is supplied to both the laser scanners. The laser light output from the laser device 100 is branched by a half mirror 101 (branch device) and is supplied to the laser scanner 106A and the laser scanner 106B. The laser scanner 106B used for the vibration measurement may have a lower scanning speed (scanning speed corresponding to the processing speed of the vibration measurement) than the laser scanner 106B used for the three-dimensional shape measurement. In the vibration measurement system of the measurement system 13, the reference light and the reflected light are interfered with each other by using the reference mirror 107 (interferometer) and a half mirror 105 (interferometer).

In Example 4 having the above-described configuration as well, the three-dimensional shape and the vibration of the object can be measured with a simple configuration, as in Examples 1 to 3. The display of the candidate regions and the measurement result can also be performed in the same manner as described above for FIGS. 11A, 11B, and 12. In addition, the measurement system 13 according to Example 4 has a feature in that the shape measurement and the vibration measurement have a high SN ratio because the light received by the laser scanner passes through the half mirror (half mirrors 105 and 102) only once until the light is input to the vibration measurer 132 and the shape measurer 120.

In addition, in the measurement system 13, it is possible to perform appropriate scanning in accordance with the speed of the shape measurement and the speed of the vibration measurement. Specifically, in the measurement system 13, the acoustic inspection can be performed by extracting and setting the candidate regions based on the measurement result of the three-dimensional shape (shape measurement and vibration measurement are separately performed), or the three-dimensional shape measurement and the acoustic inspection can be performed in parallel. The scanning pitch in these measurements can be set in the same manner as described above with reference to FIGS. 10A and 10B.

### Example 5

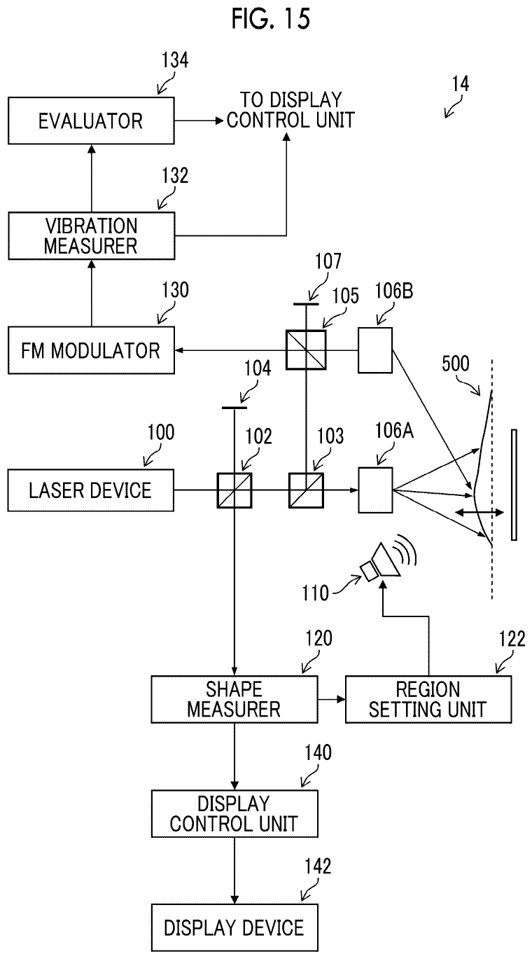

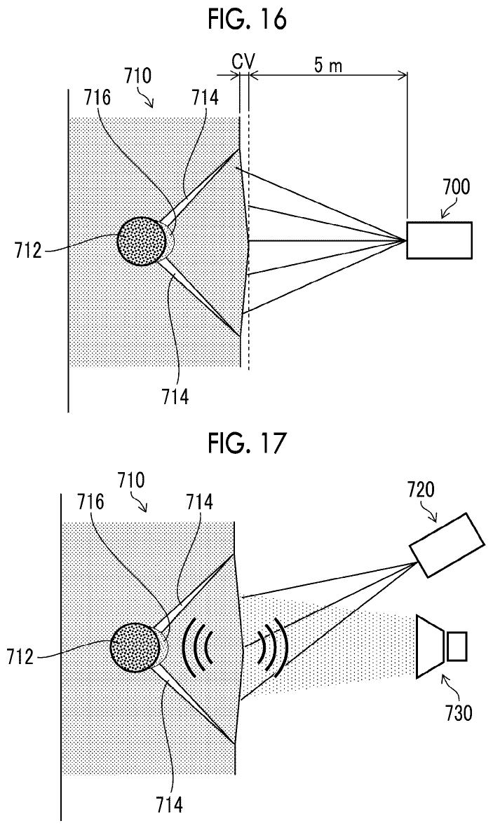

FIG. 15 is a diagram showing a configuration of a measurement system 14 (measurement system) according to Example 5. The measurement system 14 comprises a laser scanner 106A (first laser scanner) for shape measurement and a laser scanner 106B (second laser scanner) for vibration measurement, and the frequency-shifted feedback laser light is supplied to both the laser scanners, as in Example 4. The laser light output from the laser device 100 is split into two beams by the half mirror 102. One beam is reference light for shape measurement and is reflected by the reference mirror 104. The other beam is further branched by a half mirror 103 (branch device). One beam is supplied to the laser scanner 106A, the other beam is branched by the half mirror 105, one of the beams is reflected by the reference mirror 107 as reference light, and the other beam is supplied to the laser scanner 106B.

The laser scanner 106A irradiates the object 500 with the laser light, and the reflected light is combined with the reference light for shape measurement to interfere with each other, and is input to the shape measurement system (shape measurer 120 and the like) to be used for the shape measurement. The laser scanner 106B irradiates the acoustic irradiation region of the object 500 with the laser light in combination with the excitation by the excitation sound source 110. The reflected light is combined with the reference light for shape measurement to cause the interference, and is input to the vibration measurement system (FM demodulator 130 or the like) to be used for the vibration measurement or the evaluation of delamination.

In Example 5 having the above-described configuration as well, the three-dimensional shape and the vibration of the object can be measured with a simple configuration, as in Examples 1 to 4. The display of the candidate regions and the measurement result can also be performed in the same manner as described above for FIGS. 11A, 11B, and 12.

In addition, in the measurement system 14, as in Example 4, it is possible to perform appropriate scanning in accordance with the speed of the shape measurement and the vibration measurement, and the scanning pitch in these measurements can be set as described above with reference to FIGS. 10A and 10B. In addition, in a case in which the measurement system (laser device 100, half mirror 102, and reference mirror 104) including the laser light source is already present, the measurement system 14 can be easily configured by adding a device to the measurement system.

The embodiment of the present invention has been described above, but the present invention is not limited to the above-described aspects, and various modifications can be made.

### EXPLANATION OF REFERENCES

1: laser light source
2: half mirror
3: reference mirror
4: measurement object
5: light receiver
10: measurement system
11: measurement system
12: measurement system
13: measurement system
14: measurement system
100: laser device
101: half mirror
102: half mirror
103: half mirror
104: reference mirror
105: half mirror
106: laser scanner
106A: laser scanner
106B: laser scanner
107: reference mirror
108: half mirror
109: half mirror
110: excitation sound source
120: shape measurer
122: region setting unit
130: FM demodulator
132: vibration measurer
134: evaluator
140: display control unit
142: display device
500: object
600: unit region
610: unit region
620: unit region
630: region
632: region
634: region
635: acoustic irradiation region
636: region
637: acoustic irradiation region
638: region
639: region
700: laser scanner
710: object
712: reinforcing bar
714: internal cracking
716: corrosion
720: laser scanner type vibration meter
730: excitation sound source

What is claimed is:

1. A measurement system comprising:
a laser light source that outputs frequency-modulated continuous wave laser light;
a laser scanner that scans an object with the frequency-modulated continuous wave laser light;
an interferometer that splits the frequency-modulated continuous wave laser light into reference light and measurement light, and causes the reference light and reflected light of the measurement light reflected by the object to interfere with each other;
a shape measurer that measures a three-dimensional shape of the object based on a center frequency of a beat signal obtained by the interference;
an FM demodulator that performs FM demodulation on the beat signal obtained by the interference to detect FM sidebands; and
a vibration measurer that measures vibration of the object based on the FM sidebands obtained by the detection.

2. The measurement system according to claim 1,
wherein the laser light source outputs frequency-shifted feedback laser light as the frequency-modulated continuous wave laser light.

3. The measurement system according to claim 1, further comprising:
an excitation sound source that irradiates the object with sound to excite vibration,
wherein the vibration measurer measures the vibration of the object subjected to the excitation.

4. The measurement system according to claim 3, further comprising:
a region setting unit that sets an acoustic irradiation region to be irradiated with the sound,
wherein the excitation sound source irradiates the set acoustic irradiation region with the sound.

5. The measurement system according to claim 4,
wherein the region setting unit extracts candidate regions as candidates of the acoustic irradiation region based on the measured three-dimensional shape, and displays the extracted candidate regions on a display device.

6. The measurement system according to claim 5,
wherein the region setting unit extracts, as the candidate regions, a region in which a fluctuation from design information of the three-dimensional shape of the object and/or a measurement result of the three-dimensional shape acquired in advance exceeds a reference.

7. The measurement system according to claim 1,
wherein the shape measurer measures the three-dimensional shape of the object based on the center frequency of the beat signal obtained by irradiating the object with the frequency-modulated continuous wave laser light at a first pitch, and
the vibration measurer measures the vibration of the object based on the FM sidebands obtained by irradiating the object with the frequency-modulated continuous wave laser light at a second pitch larger than the first pitch.

8. The measurement system according to claim 1,
wherein the laser scanner includes a first laser scanner and a second laser scanner, both of which are supplied with the frequency-modulated continuous wave laser light,
the shape measurer measures the three-dimensional shape of the object based on the center frequency of the beat signal obtained by the first laser scanner, and
the vibration measurer measures the vibration of the object based on the FM sidebands obtained by the second laser scanner.

9. The measurement system according to claim 8, further comprising:
a branch device that branches the frequency-modulated continuous wave laser light, and supplies the branched frequency-modulated continuous wave laser light to the first laser scanner and the second laser scanner.

10. The measurement system according to claim 1, further comprising:
an evaluator that evaluates delamination of the object based on the measured vibration.

11. The measurement system according to claim 1, further comprising:
a display control unit that displays the measured three-dimensional shape and the measured vibration in association with each other on a display device.

12. The measurement system according to claim 1,
wherein the laser scanner performs the scanning on a measurement object, including any of a concrete structure, a metal member, or a plastic member, as the object.
